(19) United States
(12) Patent Application Publication
(10) Pub. No.: US 2021/0383412 A1
(43) Pub. Date: Dec. 9, 2021

(54) WALLET SERVER, WALLET SYSTEM, AND PROGRAM

(71) Applicant: TOYOTA JIDOSHA KABUSHIKI KAISHA, Toyota-shi (JP)

(72) Inventors: Yurika TANAKA, Yokosuka-shi (JP); Hideo HASEGAWA, Nagoya-shi (JP); Nozomu YOSHIOKA, Kasugai-shi (JP); Tsuyoshi TAKESHITA, Nagoya-shi (JP); Shoichiro SUZUKI, Tokyo (JP); Kohei ICHIHARA, Machida-shi (JP); Shota YAMAMOTO, Tokyo (JP); Junya CHIKANISHI, Tokyo (JP)

(73) Assignee: TOYOTA JIDOSHA KABUSHIKI KAISHA, Toyota-shi (JP)

(21) Appl. No.: 17/232,449

(22) Filed: Apr. 16, 2021

(30) Foreign Application Priority Data
Jun. 9, 2020 (JP) 2020-100082

(51) Int. Cl. G06Q 30/02; G06Q 20/36; G06Q 20/20; G06Q 20/32; H04W 4/24

(52) U.S. Cl. CPC G06Q 30/0201; G06Q 20/363; G06Q 20/202; H04W 4/80; G06Q 20/322; H04W 4/24; G06Q 30/0255

(57) ABSTRACT

A processor provided with hardware and a memory storing group consumption information containing group information containing a plurality of pieces of user information of a plurality of user terminals and consumption information associated with the group information are provided. The processor acquires notification information for performing notification about a store externally, retrieves the group consumption information based on the user information of the user terminals constituting a group, selects the notification information from the acquired notification information based on the retrieved group consumption information, and outputs the selected notification information.

### CROSS-REFERENCE TO RELATED APPLICATION

This application claims priority to Japanese Patent Application No. 2020-100082 filed on Jun. 9, 2020, incorporated herein by reference in its entirety.

### BACKGROUND

### 1. Technical Field

The present disclosure relates to a wallet server, a wallet system, and a program.

### 2. Description of Related Art

Japanese Unexamined Patent Application Publication No. 2019-087023 (JP 2019-087023 A) discloses a technique in which, when payment is adjusted via a talk room between a plurality of terminals, a server issues a payment request for one terminal to another terminal, and the server manages a payment method and payment due date of a user associated with the other terminal.

### SUMMARY

There has been a demand for a technique that can provide information that matches consumption trends and behaviors based on accumulated consumption trend data when a plurality of users gathers to constitute a group.

The present disclosure has been made in view of the above, and an object of the present disclosure is to provide a wallet server, a wallet system, and a program that can provide information that matches the consumption trends and behaviors based on the accumulated consumption trend data when the users gather to constitute a group.

A wallet server according to the present disclosure includes a processor including hardware, and a memory that stores group consumption information containing group information containing a plurality of pieces of user information of a plurality of user terminals and consumption information associated with the group information. The processor acquires notification information to perform notification about a store externally, retrieves the group consumption information from the memory based on the user information of the user terminals constituting a group, selects the notification information from the acquired notification information based on the retrieved group consumption information, and output the selected notification information.

A wallet system according to the present disclosure includes: a first device that includes a first processor provided with hardware installed in a store and outputting notification information to perform notification about the store externally; and a second device including a memory that stores group consumption information containing group information containing a plurality of pieces of user information of a plurality of user terminals and consumption information associated with the group information, and a second processor that is provided with hardware, acquires the notification information output from the first device, retrieves the group consumption information from the memory based on the user information of the user terminals constituting a group, selects the notification information from the acquired notification information based on the retrieved group consumption information, and outputs the selected notification information.

A program according to the present disclosure causes a processor provided with hardware to execute: acquisition of notification information to perform notification about a store externally; retrieval of group consumption information containing information relating to consumption of a group based on user information of a plurality of user terminals constituting the group from a memory; selection of the notification information from the acquired notification information based on the retrieved group consumption information; and output of the selected notification information.

According to the present disclosure, information that matches consumption trends and behaviors when the plurality of users are gathered in a group can be provided based on the accumulated consumption trend data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a wallet system according to an embodiment;

FIG. 2 is a block diagram schematically showing a configuration of a wallet server according to the embodiment;

FIG. 3 is a block diagram schematically showing a configuration of a payment service provider server according to the embodiment;

FIG. 4 is a block diagram schematically showing a configuration of a user terminal according to the embodiment;

FIG. 5 is a block diagram schematically showing a configuration of a store terminal according to the embodiment;

FIG. 6 is a flowchart showing an example of a processing method by the wallet system according to the embodiment;

FIG. 7 is a flowchart showing an example of a method of generating group consumption information by the wallet server according to the embodiment;

FIG. 8 is a diagram showing an example of group consumption information generated by the wallet server according to the embodiment;

FIG. 9 is a flowchart showing an example of a method of notifying notification information by the wallet server according to the embodiment;

FIG. 10 is a diagram showing a generation example of the notification information generated by the wallet server according to the embodiment;

FIG. 11 is a diagram showing a generation example of the notification information generated by the wallet server according to the embodiment;

FIG. 12 is a diagram showing a generation example of the notification information generated by the wallet server according to the embodiment; and

FIG. 13 is a diagram showing a generation example of the notification information generated by the wallet server according to the embodiment.

### DETAILED DESCRIPTION OF EMBODIMENTS

Hereinafter, embodiments of the present disclosure will be described below with reference to the drawings. In all the drawings of the following embodiments, the same or corresponding portions are designated by the same reference numerals. Further, the present disclosure is not limited to the embodiments described below. The components in the following embodiments also include those that can be easily replaced by those skilled in the art, or those that are substantially identical.

Wallet System

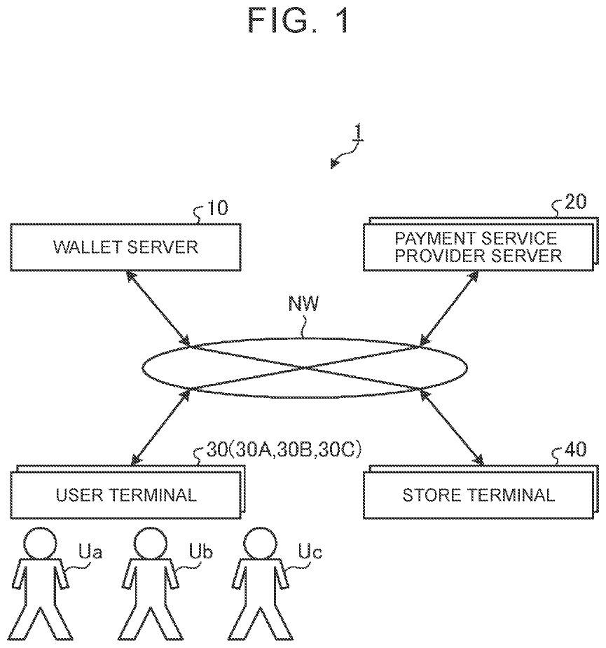

A configuration of a wallet system according to an embodiment will be described. As shown in FIG. 1, a wallet system 1 includes a wallet server 10, a payment service provider server 20, a user terminal 30, and a store terminal 40.

The wallet server 10, the payment service provider server 20, the user terminal 30, and the store terminal 40 are configured to be communicable with each other via a network NW. The network NW is composed of, for example, the Internet network and a mobile phone network. The network NW may include, for example, other communication networks such as a wide area network (WAN), a telephone communication network such as a mobile phone, and a wireless communication network such as Wi-Fi (registered trademark).

Wallet Server

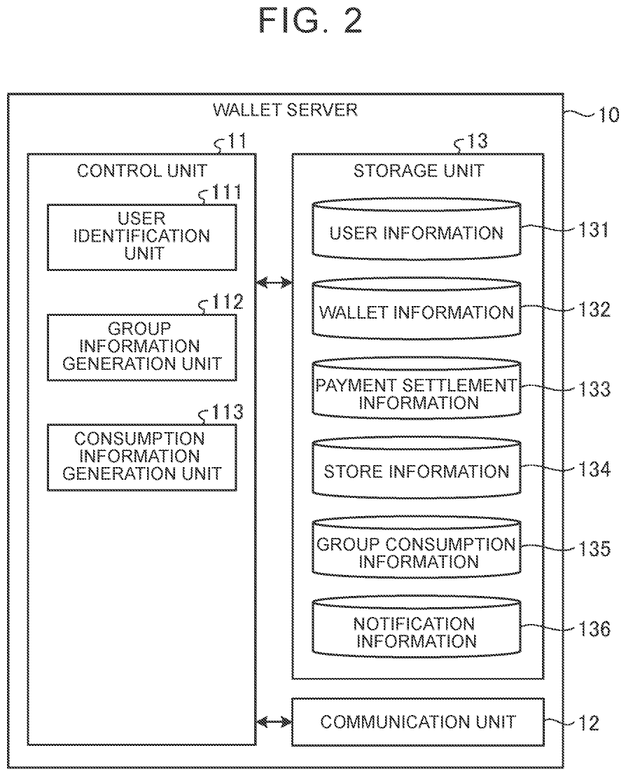

The wallet server 10 as a second device including a wallet server is a server for comprehensively managing the wallet system according to the present embodiment, and is managed by a wallet system administrator. As shown in FIG. 2, the wallet server 10 includes a control unit 11 as a second processor, a communication unit 12, and a storage unit 13.

Specifically, the control unit 11 is composed of a processor that is provided with hardware, such as a central processing unit (CPU), a digital signal processor (DSP), and a field-programmable gate array (FPGA), and a main storage unit, such as a random access memory (RAM) and a read-only memory (ROM). The storage unit 13 includes, for example, a recording medium selected from an erasable programmable ROM (EPROM), a hard disk drive (HDD), and a removable medium, etc. Examples of the removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc.

The control unit 11 loads a program stored in the storage unit 13 into a work area of the main storage unit and executes the loaded program, and controls each component unit, etc. through execution of the program. The program may be a learned model generated through machine learning, for example. The learned model can be generated through machine learning such as deep learning using a neural network, for example, with an input-output data set of a predetermined input parameter and an output parameter as teaching data. With the configuration above, the control unit 11 can realize functions of a user identification unit 111, a group information generation unit 112, and a consumption information generation unit 113. The details of the functions of the user identification unit 111, the group information generation unit 112, and the consumption information generation unit 113 will be described later.

The communication unit 12 as an information acquisition unit is composed of, for example, a local area network (LAN) interface board or a wireless communication circuit for wireless communication. The LAN interface board and the wireless communication circuit are connected to the network NW such as the Internet, which is a public communication network. The communication unit 12 connects to the network NW and communicates with the payment service provider server 20, the user terminal 30, and the store terminal 40.

The storage unit 13 includes, for example, a recording medium such as an erasable programmable ROM (EPROM), a hard disk drive (HDD), and a removable medium. Examples of removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc. The storage unit 13 according to the present embodiment stores user information 131, wallet information 132, and payment settlement information 133 for each user of the wallet system 1. Further, the storage unit 13 stores store information 134, group consumption information 135, and notification information 136.

The user information 131 is information about the user who uses the wallet system 1. Examples of the user information 131 include, for example, a user ID, a password, a user name, user contact information (for example, an address, a telephone number, and an e-mail address), usage registration history, and information on payment means registered as deposit means, information on payment means registered as payment settlement means, and a password for making a payment settlement, of a user who has registered for use of the wallet system. The user ID and the password in the user information 131 are used for authentication processing such as logging in to the wallet server 10.

The wallet information 132 is information related to a wallet of the wallet system 1. The wallet is a virtual deposit and withdrawal account of electronic money. The wallet information 132 includes, for example, the user ID, a balance of the electronic money, a deposit history of the electronic money, and a usage history of the electronic money.

The payment settlement information 133 is information related to payment settlement of the wallet system. The payment settlement information 133 includes the user ID, a payment settlement method used for making a payment settlement (e.g. payment by the electronic money (non-contact payment), payment by scanning, or payment by code), date and time information containing a date and time when the payment settlement is made, and a payment settlement history.

The store information 134 is information relating to facilities and terminals of the stores that use the wallet system 1. The store information 134 contains, for example, location information, information on foods, menus and services available, information on business dates and times, and information on coupons and campaigns, of store facilities such as various restaurants and cafeterias that provide food and services.

The group consumption information 135 contains information (group information) of a group composed of a plurality of users who uses the store, and information (consumption information) on consumption for each user associated with the group. That is, the group consumption information 135 contains the group information containing user information that can distinguish the users who are grouped together as a group. The group consumption information 135 further contains consumption information on products and amounts of money consumed by each user.

The notification information 136 is associated with the store information 134 and contains coupon information that is information about reward points and coupons that can be used in the store, and information such as advertisements of and services and products provided by a store 2. The notification information 136 may be contained in the store information 134.

Payment Service Provider Server

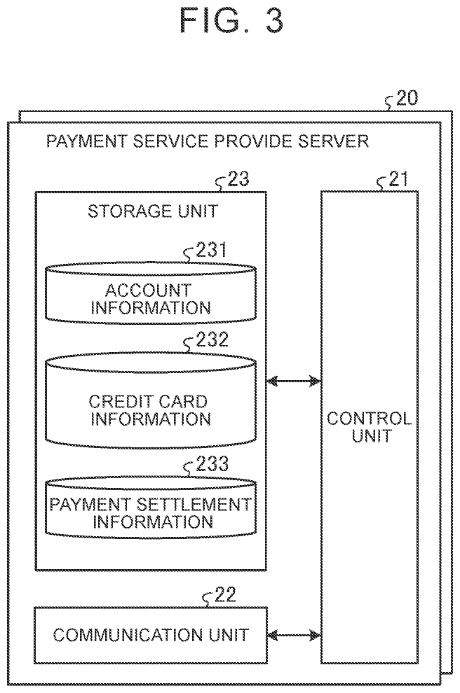

The payment service provider server 20 is a server for managing an account and a credit card of the user. The payment service provider server 20 is installed in a financial institution such as a bank, a Shinkin bank, a credit union, or a labor bank, or a credit card company. As shown in FIG. 3, the payment service provider server 20 includes a control unit 21, a communication unit 22, and a storage unit 23. The control unit 21, the communication unit 22, and the storage unit 23 are functionally the same as the control unit 11, the communication unit 12, and the storage unit 13, respectively.

The storage unit 23 stores account information 231, credit card information 232, and payment settlement information 233 for each user of the wallet system 1. The account information 231 contains, for example, the name of the user, an account number, an account balance, and a deposit and withdrawal history. The credit card information 232 contains, for example, the name of the user, a credit card number, an expiration date of the credit card, a usage limit amount, and a card usage history. Examples of the payment settlement information 233 include the user ID, the payment settlement means, and the payment settlement history. The storage unit 23 may further store reward point information on return of reward points held by the payment service provider, etc., and campaign information that is information on reward points returned and various campaigns held by a payment settlement service provider. Examples of the reward point information include, for example, the name of the user, a unique user ID, the number of reward points associated with the account information or the credit card information. Examples of the campaign information include information on the reward point rate when a predetermined payment settlement method is used, information on an area where the campaign is carried out, and information on coupons provided to the user.

User Terminal

The user terminal 30 (30A, 30B, 30C) is a computer terminal operated by the user. Examples of the user terminal 30 include smartphones, mobile phones, tablet terminals, wearable computers, and personal computers held by the user, and car navigation systems mounted on vehicles. The user terminal 30 may be any terminal as long as the user terminal 30 can transmit and receive information to and from the wallet server 10.

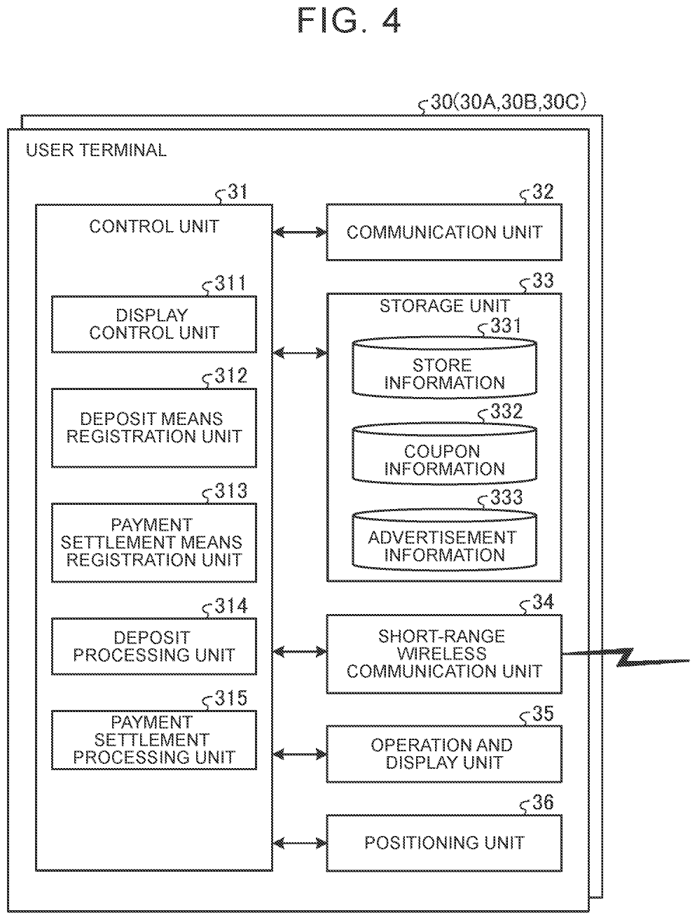

As shown in FIG. 4, the user terminal 30 as a third device includes a control unit 31, a communication unit 32, a storage unit 33, a short-range wireless communication unit 34, an operation display unit 35, and a positioning unit 36. The control unit 31, the communication unit 32, and the storage unit 33 are functionally the same as the control unit 11, the communication unit 12, and the storage unit 13 in the wallet server 10 shown in FIG. 2, respectively. As shown in FIG. 4, the control unit 31 as a third processor functions as a display control unit 311, a deposit means registration unit 312, a payment settlement means registration unit 313, a deposit processing unit 314, and a payment settlement processing unit 315. Further, in FIGS. 1 and 4, the three user terminals 30A, 30B, and 30C are provided. However, the present disclosure is not necessarily limited to three user terminals.

The display control unit 311 controls contents to be displayed on an operation display unit 35 including a display. The display control unit 311 displays, for example, a member registration screen when the user registers as a member, a log-in screen when the user logs in to the wallet system 1, and a deposit screen when the user deposits money to the electronic money of the wallet, and a payment settlement screen when the user makes a payment settlement, on the operation display unit 35 to be operated based on user operations such as a touch operation and a flick operation by the user. In addition, the display control unit 311 transitions each screen based on the operations of the user.

The deposit means registration unit 312 registers the deposit means for depositing money to the electronic money. The deposit means registration unit 312 transmits, to the wallet server 10, a deposit means registration request for registering a plurality of different payment settlement methods operated by a plurality of service providers as means of depositing money to the electronic money. Specifically, the different payment settlement methods operated by the service providers includes, for example, the bank account and the credit card. The control unit 11 of the wallet server 10 that receives the deposit means registration request from the deposit means registration unit 312 stores the payment settlement method contained in the deposit means registration request in the storage unit 13 as the user information 131 and registers the payment settlement method as the deposit means.

The payment settlement means registration unit 313 registers various payment settlement means. The payment settlement means registration unit 313 transmits a payment settlement means registration request for registering the payment settlement means to the wallet server 10. The control unit 11 of the wallet server 10 that receives the payment settlement means registration request from the payment settlement means registration unit 313 stores the payment settlement method contained in the payment settlement means registration request in the storage unit 13 as the user information 131 to register the payment settlement method as the payment settlement means. In addition, a payment settlement method may be registered instead of the payment settlement means.

The deposit processing unit 314 deposits money to the electronic money in the wallet. Specifically, the deposit processing unit 314 transmits, to the wallet server 10, a deposit request for depositing money to the electronic money using the payment settlement means registered as the deposit means. The control unit 11 of the wallet server 10 that receives the deposit request from the deposit processing unit 314 increments a balance of the electronic money in the wallet based on deposit amount information contained in the deposit request. That is, the control unit 11 updates the wallet information 132 stored in the storage unit 13 in accordance with an increment in the balance of the electronic money in the wallet.

The payment settlement processing unit 315 executes payment settlement using the payment settlement method selected by the user. Specifically, the payment settlement processing unit 315 transmits a payment settlement request to the store terminal 40 via the short-range wireless communication unit 34 as the payment settlement means. The payment settlement processing unit 315 may transmit the payment settlement request to the store terminal 40 by reading a one-dimensional code (also referred to as a one-dimensional symbol) such as a barcode or a two-dimensional code (also referred to as a two-dimensional symbol) such as a QR code (registered trademark) (hereinafter collectively referred to as a bar code symbol based on the International Standardization Organization (ISO) Standard and the International Electrotechnical Commission (IEC) Standard) displayed on the store terminal 40 using a camera, etc., of the user terminal 30. The payment settlement processing unit 315 may transmit the payment settlement request to the store terminal 40 by causing a code reader, etc., of the store terminal 40 to read a code displayed on the user terminal 30 as the payment settlement means. The payment settlement request transmitted from the payment settlement processing unit 315 to the store terminal 40 may or may not contain information indicating a payment settlement amount (hereinafter referred to as “payment settlement amount information”).

When the user makes payment settlement with the bank account or by the credit card, the payment settlement processing unit 315 transmits the payment settlement request to the wallet server 10 to make a payment settlement using any of the payment settlement means. The control unit 11 of the wallet server 10 that receives the payment settlement request from the payment settlement processing unit 315 transmits the payment settlement amount information contained in the payment settlement request to the payment service provider server 20.

Further, when the user makes a payment settlement by the electronic money, a control unit 41 of the store terminal 40, which will be described later, transmits the payment settlement request containing the payment settlement amount information to the wallet server 10 via the network NW. The control unit 11 of the wallet server 10 that receives the payment settlement request from the store terminal 40 deducts the payment settlement amount from the balance of the electronic money in the wallet based on the payment settlement amount contained in the payment settlement request. That is, the control unit 11 updates the wallet information 132 and the payment settlement information 133 stored in the storage unit 13 in accordance with the deduction in the balance of the electronic money in the wallet.

The storage unit 33 stores various screen data to be displayed on the operation display unit 35 by the display control unit 311. Further, the storage unit 33 temporarily stores the user information 131, the wallet information 132, the payment settlement information 133, and reward point information, for example, as needed. The storage unit 33 stores store information 331, coupon information 332, and advertisement information 333 that can be used by the user as needed. The coupon information 332 includes information such as coupons and reward points that can be used at stores, etc. The advertisement information 333 contains information such as an advertisement associated with the store information 331 and services and products provided at the store 2.

The short-range wireless communication unit 34 has a communication function conforming to standards such as near field radio communication (NFC), Bluetooth (registered trademark) low energy (BLE), and infrared data association (IrDA). For example, when the user makes a payment settlement using the electronic money, the user terminal 30 performs short-range wireless communication with the store terminal 40 via the short-range wireless communication unit 34.

The operation display unit 35 is composed of, for example, a touch panel display, and has an input function for receiving an operation using a finger of the user or a pen, and a display function for displaying various pieces of information under the control of the display control unit 311.

The positioning unit 36 receives radio waves from a global positioning system (GPS) satellite and detects the location information of the user terminal 30. The control unit 31 transmits the location information of the user terminal 30 to the wallet server 10, the payment service provider server 20, or the store terminal 40 via the network NW.

Store Terminal

The store terminal 40 as a first device is provided in, for example, the store 2 that is a member store where the wallet system 1 can be used. The store terminal 40 may be a server that also functions as a virtual store opened on the Internet, a so-called electronic commerce (EC) site.

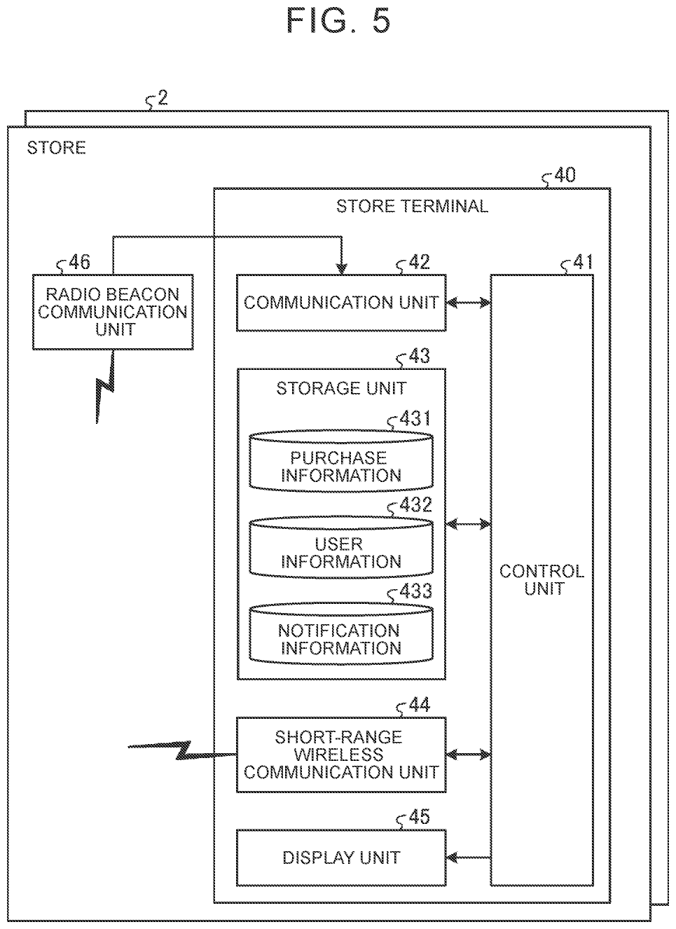

As shown in FIG. 5, the store terminal 40 includes the control unit 41, a communication unit 42, a storage unit 43, a short-range wireless communication unit 44, and a display unit 45. The control unit 41 as a first processor, the communication unit 42, the storage unit 43, and the short-range wireless communication unit 44 are functionally the same as the control unit 11, the communication unit 12, the storage unit 13, and the short-range wireless communication unit 34, respectively. The display unit 45 is composed of, for example, a liquid crystal display (LCD) and an organic electroluminescence display (OLED), and displays information under the control of the control unit 41.

The storage unit 43 stores purchase information 431, user information 432, and notification information 433. The purchase information 431 contains various pieces of information such as a purchased product, a purchase price, and purchase date and time regarding the purchase of the user at the store 2. The user information 432 is user information acquired by the store terminal 40 from the user terminal 30. The user information 432 may be associated with the purchase information 431. The notification information 433 contains various pieces of information that can be provided to the users Ua to Uc in relation to the store 2, such as advertisement information, coupon information, and service information related to the store 2.

The store 2 provided with the store terminal 40 may be provided with a radio beacon communication unit 46. The radio beacon communication unit 46 has, for example, an infrared beacon (IR beacon) realized by a radio beacon technology using infrared rays, or a communication function conforming to the BLE having a proximity notification function capable of identifying the user terminal 30 by receiving a signal from the target user terminal 30. The radio beacon communication unit 46 is not limited to the case where the radio beacon communication unit 46 is provided in the store 2, and may be provided at a position along the road or in various facilities.

Consumption Trend Collection Method by Wallet Server

Next, a consumption trend collection method by the wallet system 1 including the wallet server 10 according to the present embodiment will be described. In the following description, information is transmitted and received via the network NW. The description of transmission and reception via the network NW will be omitted. Further, when information is transmitted and received among the wallet server 10, each payment service provider server 20, each user terminal 30, and each store terminal 40, the information is transmitted and received in association with the identification information to independently identify the payment service provider server 20, the user terminal 30, and the store terminal 40. However, the description thereof will also be omitted.

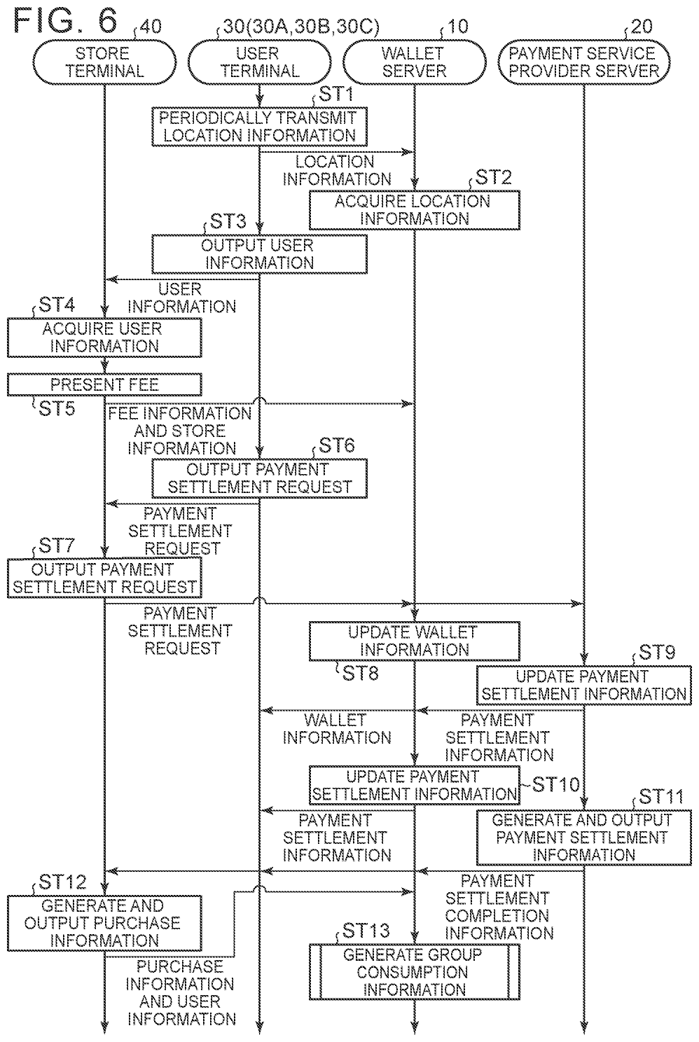

As shown in FIG. 6, first, in step ST1, the user terminals 30A, 30B, 30C each periodically or timely transmit location information to the wallet server 10. In step ST2, the control unit 11 of the wallet server 10 stores the received location information of the user terminals 30A to 30C in the storage unit 13 as the user information 131. In the following description, users Ua, Ub, Uc hold the user terminals 30A, 30B, 30C, respectively, and use the store 2 as a group. The number of users acting in a group is not necessarily limited to three, and may be two or four or more.

In steps ST3 and ST4, the store terminal 40 acquires the user information 432 that can identify the respective user terminals 30A to 30C from the user terminals 30A to 30C held by the users Ua to Uc who visit the store, respectively. The storage unit 43 stores the user information 432 acquired by the store terminal 40. As a method of acquiring the user information 432, the following various methods can be adopted.

For example, in step ST3, the user terminals 30A to 30C held by the users Ua to Uc communicate with the radio beacon communication unit 46 provided in the store 2. With the processing above, in step ST4, the user information is output from the radio beacon communication unit 46 to the store terminal 40, and the store terminal 40 can acquire the user information 432 containing the user ID as user-specific information related to the user terminals 30A to 30C. When the users Ua to Uc are members in a group, the communication between the user terminals 30A to 30C and the radio beacon communication unit 46 is continuously performed. Therefore, a communication time stamp, for example, is close to each other. Therefore, the user information 432 acquired from each of the user terminals 30A to 30C can be associated with each other based on the communication time stamp, etc.

For example, in step ST4, the store terminal 40 can acquire the user information 432 as a code reader, for example, of the store terminal 40 reads the barcode symbols displayed on the user terminals 30A to 30C, such as the barcode symbol for coupons in step ST3. When the users Ua to Uc are members of the group, the user terminals 30A to 30C are made to display the barcode symbols associated with each other and the common barcode symbols. Association of the barcode symbols with each other can be realized as the short-range wireless communication units 34 of the user terminals 30A to 30C communicate with each other. With the processing above, the user information 432 acquired from each of the user terminals 30A to 30C can be associated with each other.

For example, in step ST3, the display unit 45 of the store terminal 40 can display a different barcode symbol each time the display is switched. The same barcode symbol is read by the cameras of the user terminals 30A to 30C included in the group, and the user information 432 can be acquired in step ST4. When the users Ua to Uc are members in the group, the barcode symbol read by the user terminals 30A to 30C becomes a one-time barcode. Therefore, the user information 432 acquired from the user terminals 30A to 30C can be associated with each other.

The users Ua to Uc who have entered the store 2 provided with the store terminal 40 eat, receive a predetermined service from a clerk, and hand over the product to the clerk. In step ST5, the clerk urges the user Ua of the user terminal 30A to pay a fee using the store terminal 40. The user Ua makes a payment for total of fees of the users Ua to Uc on behalf of the users Ua to Uc. The control unit 41 causes the display unit 45 of the store terminal 40 to display the amount of fee. The store terminal 40 transmits fee information and the store information to the wallet server 10.

After the step above, in step ST6, the payment settlement processing unit 315 of the user terminal 30 issues, to the store terminal 40, the payment settlement request for settling the payment settlement amount determined in step ST5 using the electronic money deposited in the wallet or by displaying a predetermined code, for example. During the processing above, the payment settlement processing unit 315 of the user terminal 30 may output the user information to the store terminal 40.

Subsequently, in step ST7, the control unit 41 outputs the payment settlement request acquired from the user terminal 30 to the wallet server 10 and the payment service provider server 20. During the processing above, the control unit 41 may output the user information acquired from the user terminal 30 to the wallet server 10 and the payment service provider server 20. Note that, the payment settlement request may be transmitted to either of the wallet server 10 and the payment service provider server 20. Further, the user information may be transmitted from the store terminal 40 to the wallet server 10 in response to a transmission request from the wallet server 10.

In step ST8, the control unit 11 of the wallet server 10 updates the wallet information 132 stored in the storage unit 13 in accordance with the payment settlement amount. When the control unit 11 receives the user information, the control unit 11 may update the user information 131. The control unit 11 transmits the updated wallet information 132 to the user terminal 30.

In step ST9, the control unit 21 of the payment service provider server 20 updates the payment settlement information 233 stored in the storage unit 23 in accordance with the payment settlement amount. The payment service provider server 20 transmits the updated payment settlement information 233 to the wallet server 10.

In step ST10, the control unit 11 of the wallet server 10 updates the payment settlement information 133 stored in the storage unit 23 with the received payment settlement information 233. The control unit 11 transmits the updated payment settlement information 133 to the user terminal 30.

Subsequently, in step ST11, the control unit 21 of the payment service provider server 20 transmits payment settlement completion information containing the content indicating that the payment settlement processing is completed to the wallet server 10, the user terminal 30, and the store terminal 40. Note that, the control unit 11 of the wallet server 10 may execute all of steps ST8 to ST11. Further, the control unit 21 of the payment service provider server 20 may execute all of steps ST8 to ST11.

In step ST12, the control unit 41 of the store terminal 40 generates the purchase information 431. That is, after receiving the payment completion information, the control unit 41 generates the purchase information 431 containing information on products and services for which payments are settled by the user using the user terminal 30 and the payment settlement amount, etc. For example, when the users Ua to Uc eat at the store 2 and the user Ua makes a payment settlement on behalf of the users Ua to Uc, the control unit 41 generates the purchase information 431 containing information on the contents of menus for meals of the users Ua to Uc, and information on the prices of menus of the respective users, etc. The control unit 41 associates the generated purchase information 431 with the user information 432 acquired in step ST4 and transmits the information to the wallet server 10. The control unit 11 of the wallet server 10 stores the received purchase information 431 contained in the store information 134 in the storage unit 13, and stores the received user information 432 in the storage unit 13 as the user information 131.

After that, in step ST13, the control unit 11 of the wallet server 10 generates the group information and the consumption information so as to generate the group consumption information 135.

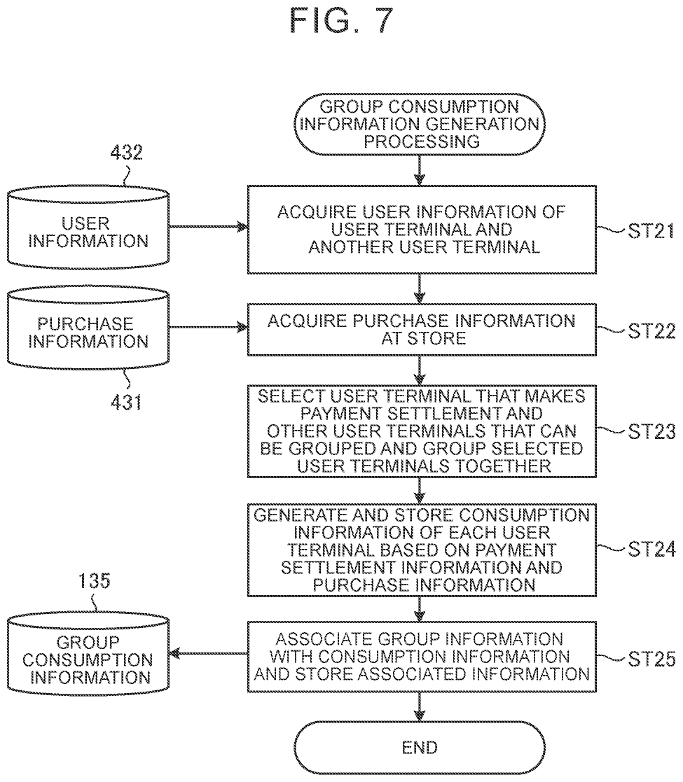

Specifically, as shown in FIG. 7, first, in step ST21, the user identification unit 111 of the control unit 11 acquires, with the plurality of user terminals 30, the user information 131 in the user terminals 30A to 30C held by the users Ua to Uc from the storage unit 13. With the processing above, the user identification unit 111 can acquire the user information 432 received from the store terminal 40. Further, in step ST22, the user identification unit 111 reads out and acquires, from the storage unit 13, the purchase information 431 received from the store terminal 40.

Next, in step ST23, the group information generation unit 112 of the control unit 11 selects the user information 131 of the user terminal 30A of the user Ua who has made the payment settlement at the store 2 from the acquired user information 432 based on the purchase information 431. Next, the group information generation unit 112 retrieves, from the user information 131, other user terminals that can be grouped with the user terminal 30A of the user Ua, that is, the user terminals 30B, 30C of the users Ub, Uc, based on the information contained in the acquired user information 432. The information contained in the user information 432 includes, for example, the location information on the users Ua to Uc at the time when the users Ua to Uc use the store 2, information on reading of the barcode symbol using the user terminals 30A to 30C at the store 2, and information on reading of the barcode symbol that are displayed by the user terminals 30A to 30C and read by the store terminal 40. With the configuration above, the group information generation unit 112 identifies each of the users Ua to Uc who have used the store 2 as a group, and generates the group information in the group consumption information 135.

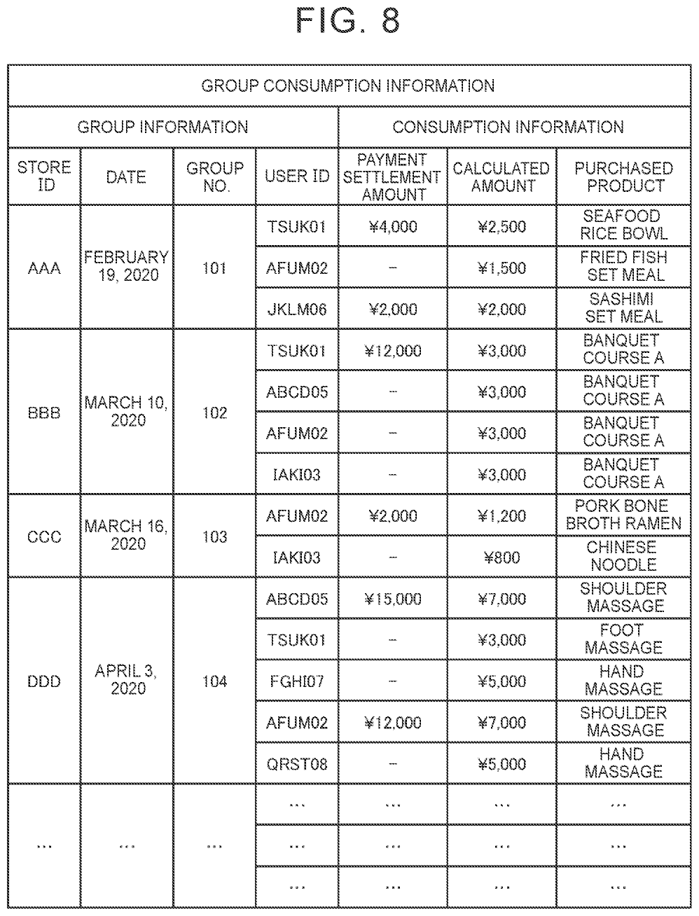

As shown in FIG. 8, the group information contains a store ID of the store 2 where the payment settlement has been made and the date when the group uses the store 2. The group information contains a user ID to which a group number that is the number for distinguishing the group is assigned and that is contained in the user information 131 of each of the users Ua to Uc. Other symbols, etc, may be used as the group number as long as the groups are distinguished from each other in the group information.

Next, in step ST24 shown in FIG. 7, the consumption information generation unit 113 of the wallet server 10 generates consumption information of each of the users Ua to Uc in the group consumption information 135 based on the payment settlement information 133 and the purchase information 431 contained in the acquired store information 134. After that, in step ST25, the consumption information generation unit 113 of the control unit 11 associates the group information with the consumption information generated as described above based on the payment settlement information 133 and the user information 131 associated with the purchase information 431, and generates the group consumption information 135. The consumption information generation unit 113 then stores the group consumption information 135 in the storage unit 13. With the processing above, the generation processing of the group consumption information 135 containing the consumption information associated with the group information is completed.

Here, a specific example of the group consumption information 135 will be described with reference to FIG. 8. As shown in FIG. 8, specifically, with a group having the group number (group No.) “101” as an example, the user Ua (user ID: “TSUK01”) makes a payment settlement for 4,000 yen at the store 2 having the store ID “AAA” on Feb. 19, 2020. Further, the user Uc (e.g. user ID: “JKLM06”) makes a payment settlement for 2,000 yen independently. The consumption information generation unit 113 calculates the amount to be paid by another user Ub (user ID: “AFUM02”) as a calculated amount based on the payment settlement amounts of the payment settlement processing executed by the users Ua, Uc.

Further, with a group having the group number (group No.) “102” as an example, the user Ua (user ID: “TSUK01”) in the group makes a payment settlement for 12,000 yen at the store 2 having the store ID “BBB” on Mar. 10, 2020. After that, the consumption information generation unit 113 calculates the amount to be paid by four member users of the group. In FIG. 8, the consumption information generation unit 113 performs a calculation such that each user evenly pays 3,000 yen (obtained by dividing 12,000 by four). Note that, the calculated amount can be appropriately changed by the user who has made the payment settlement. As described above, when the products purchased at the store 2 contained in the purchase information 431 are products that are consumed by the entire group, such as “banquet course A”, the calculated amount may be calculated such that the amount for each user becomes substantially even or substantially equal.

Further, with a group having the group number (group No.) “104” as an example, one user (user ID: “ABCD05”) makes a payment settlement for 15,000 yen, and another user (user ID: “AFUM02”) makes a payment settlement for 12,000 yen. In this case, the consumption information is generated based on selection of members set by the two users who have made the payment settlement. In the example shown in FIG. 8, the user having the user ID “ABCD05” pays for the services received by two other users (user IDs: “TSUK01” and “FGHI07”) together. In this case, the consumption information generation unit 113 calculates the amount of money consumed by the two users (user IDs: “TSUK01” and “FGHI07”) as the calculated amounts based on the purchase information 431. Similarly, the user having user ID “AFUM02” pays for the service received by one user (user ID: “QRST08”) together. The consumption information generation unit 113 calculates the amount of money consumed by one user (user ID: “QRST08”) as the calculated amount based on the purchase information 431. As described above, the generated group consumption information 135 is stored and collected in the storage unit 13. That is, the group consumption information 135 is accumulated as big data in the storage unit 13 of the wallet server 10.

Notification Method of Notification Information by Wallet Server

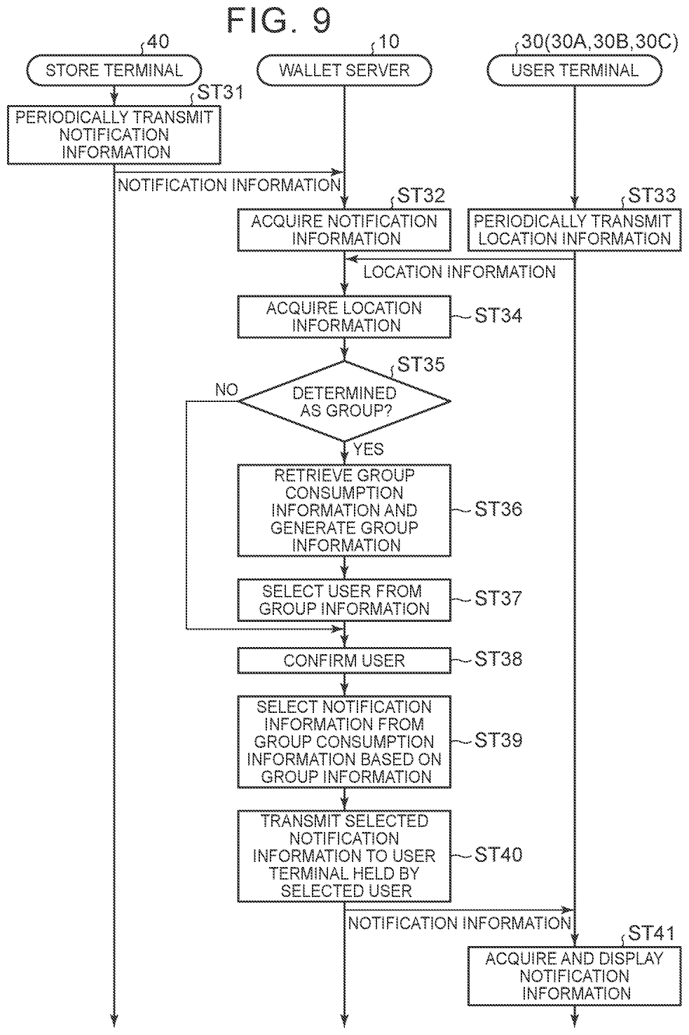

Next, a notification method of the notification information using the consumption trend data accumulated as described above will be described. As shown in FIG. 9, first, in step ST31, the control unit 41 of the store terminal 40 periodically or timely transmits the notification information 433 to the wallet server 10. The control unit 11 of the wallet server 10 that has acquired the notification information 433 in step ST32 stores the acquired notification information 433 in the storage unit 13 as the notification information 136.

On the other hand, in step ST33, the user terminals 30 (30A, 30B, 30C) periodically or timely transmit the location information to the wallet server 10 in the same manner as in step ST1. In step ST34, the control unit 11 of the wallet server 10 stores the acquired location information in the storage unit 13 as the user information 131. The order of steps ST31 and ST32 and the steps ST33 and ST34 may be reversed.

In step ST35, the user identification unit 111 of the control unit 11 determines whether the user terminals 30, for example, the user terminals 30A to 30C, constitute a group.

Here, the user identification unit 111 can determine whether the users Ua to Uc holding the user terminals 30A to 30C are members of the group based on the location information of the user terminals 30A to 30C at a predetermined time. That is, when the locations contained in the location information sent from the user terminals 30A to 30C are within a predetermined distance from each other at the predetermined time, the user identification unit 111 can determine that the users Ua to Uc holding the user terminals 30A to 30C are members of the group.

Further, the user identification unit 111 acquires information on execution of the short-range communication such as NFC or infrared communication mutually among the user terminals 30A to 30C. The user identification unit 111 can then determine whether the users Ua to Uc are members of the group based on whether the short-range communication is executed.

Further, the user identification unit 111 can determine whether the users Ua to Uc are members of the group through communication between a radio beacon communication unit provided at a location along the road or at various facilities and the user terminals 30A to 30C, similar to the radio beacon communication unit 46. That is, when the users Ua to Uc are members of the group, the communication between the user terminals 30A to 30C and the radio beacon communication unit 46 is constantly and continuously performed. Therefore, the communication time stamp becomes close and the communication time becomes long. Therefore, the user information acquired from each of the user terminals 30A to 30C can be associated with each other based on the communication time stamp and the communication time. With the processing above, the radio beacon communication unit acquires the user information from the user terminals 30A to 30C and outputs the acquired user information to the wallet server 10, whereby the user identification unit 111 can determine whether the user terminals 30A to 30C constitute a group.

As the method for determining the group using the user identification unit 111, one of the methods described above may be used, or a plurality of the methods above may be used in combination.

When the user identification unit 111 determines in step ST35 that the user terminals 30A to 30C constitute a group (step ST35: Yes), the processing proceeds to step ST36. In step ST36, the user identification unit 111 confirms that the users Ua to Uc holding the user terminals 30A to 30C are members of the group. Subsequently, the user identification unit 111 retrieves the user IDs of the user terminals 30A to 30C confirmed as the group from the user information 131 stored in the storage unit 13. Next, the user identification unit 111 retrieves the group consumption information 135 containing all of the user IDs from the group consumption information 135 based on the retrieved user IDs. Subsequently, the group information generation unit 112 retrieves the group information from the retrieved group consumption information 135.

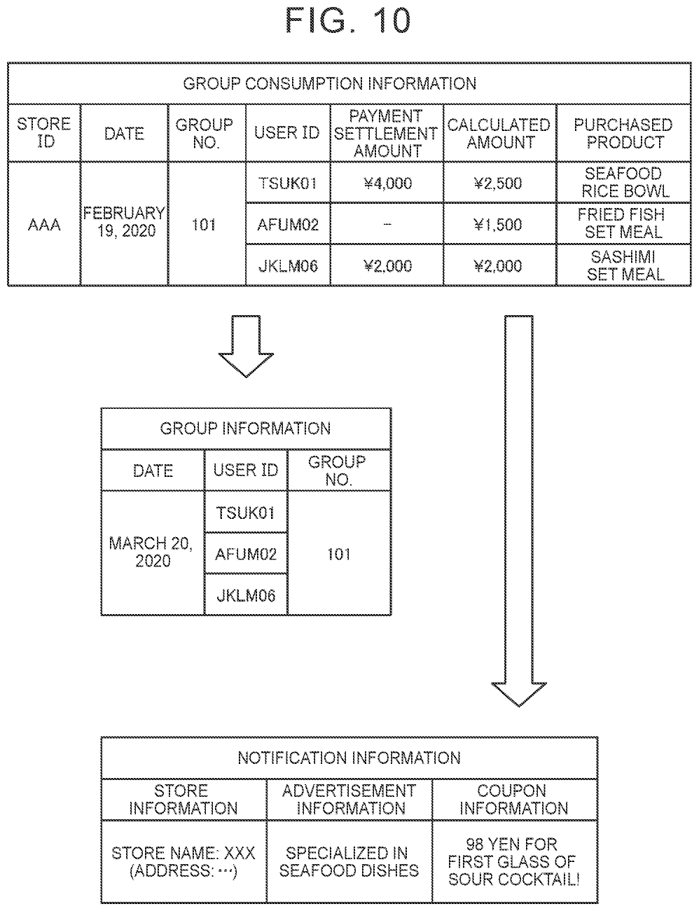

That is, as shown in FIG. 10, when the user IDs in the user terminals 30A to 30C are “TSUK01”, “AFUMI02”, and “JKLM06”, the group information generation unit 112 retrieves the group consumption information 135 containing the group number “101”. The group information generation unit 112 generates the group information from the date, the user IDs, and the group number determined to be a group by the user identification unit 111 based on the retrieved group consumption information 135. The generated group information is stored in the storage unit 13.

Next, the processing proceeds to step ST37 shown in FIG. 9. The user identification unit 111 selects one or more user IDs based on at least one of the generated group information and the retrieved group consumption information 135. Note that, all of the user IDs may be selected. Here, for example, the user Ua is selected.

Next, the processing proceeds to step ST38. The user identification unit 111 determines the user from the group based on the selected user ID. When the user identification unit 111 determines that the user terminals 30A to 30C do not constitute a group (step ST35: No) and the processing proceeds to step ST38, the users Ua to Uc of the user terminals 30A, 30B, and 30C are respectively confirmed as the selected users.

Next, the processing proceeds to step ST39. The user identification unit 111 selects the notification information 136 based on the group consumption information containing the generated group information. Specifically, as shown in FIG. 10, the user identification unit 111 selects the predetermined store 2 based on the group consumption information 135 retrieved in step ST36 and the generated group information, and retrieves the notification information 136 acquired from the store 2. In other words, the user identification unit 111 selects the notification information 136 of the store 2 selected based on the group consumption information 135 corresponding to the group information from a plurality of pieces of notification information 136 acquired from the store terminals 40. When the user identification unit 111 determines in step ST35 shown in FIG. 9 that the user terminals 30A to 30C do not constitute a group, the user identification unit 111 can select the notification information 136 based on the group consumption information 135 containing the user Ua.

The processing proceeds to step ST40. The consumption information generation unit 113 transmits the selected notification information 136 to the user terminal 30A of the user Ua selected in step ST38. The user terminal 30A that has received the notification information 136 in step ST41 stores the acquired notification information 136 in the storage unit 33. The display control unit 311 of the user terminal 30A causes the operation display unit 35 to be capable of displaying the acquired notification information 136. With the processing above, the notification processing of the notification information 136 by the wallet server 10 is completed.

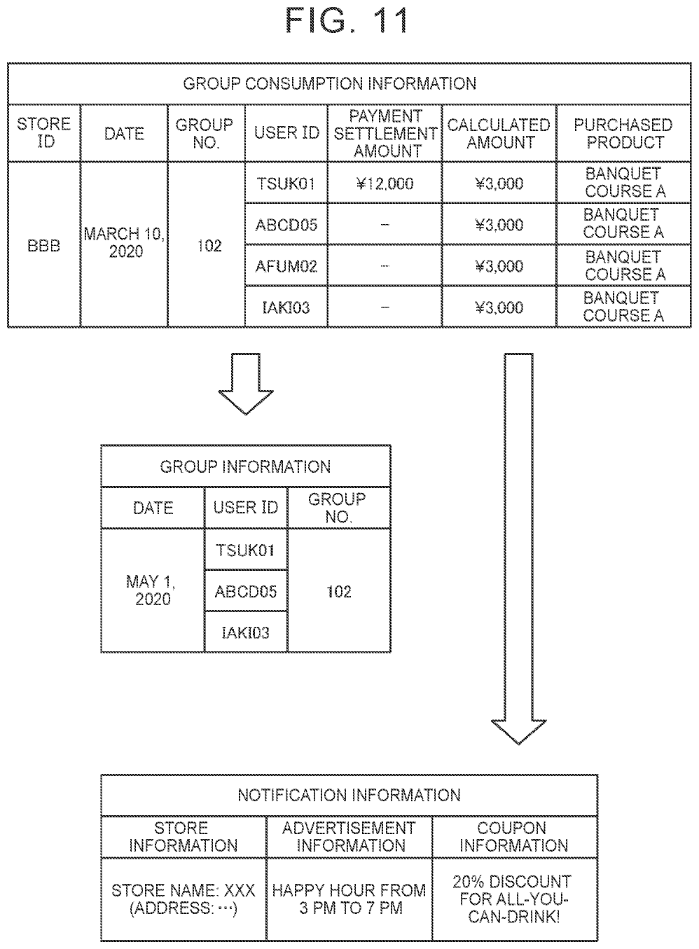

Further, FIGS. 11, 12, and 13 each show examples of the group consumption information 135, the group information generated based on the determination as a group, and the notification information 136 selected based on the generated group information and the retrieved group consumption information 135.

As shown in FIG. 11, when the user IDs of the user terminals 30A to 30C constituting a group are “TSUK01”, “ABCD05”, and “IAKI03”, respectively, the group information generation unit 112 retrieves the group consumption information 135 containing the user IDs above. Here, the group having the group number “102” is selected. However, the group having the group number “102” can be selected even when the user ID “AFUM02” is not included. The group information generation unit 112 generates the group information from the date, the user IDs, and the group number determined to be a group by the user identification unit 111 based on the retrieved group consumption information 135. In this case, the group number may be different from “102”. The generated group information is stored in the storage unit 13.

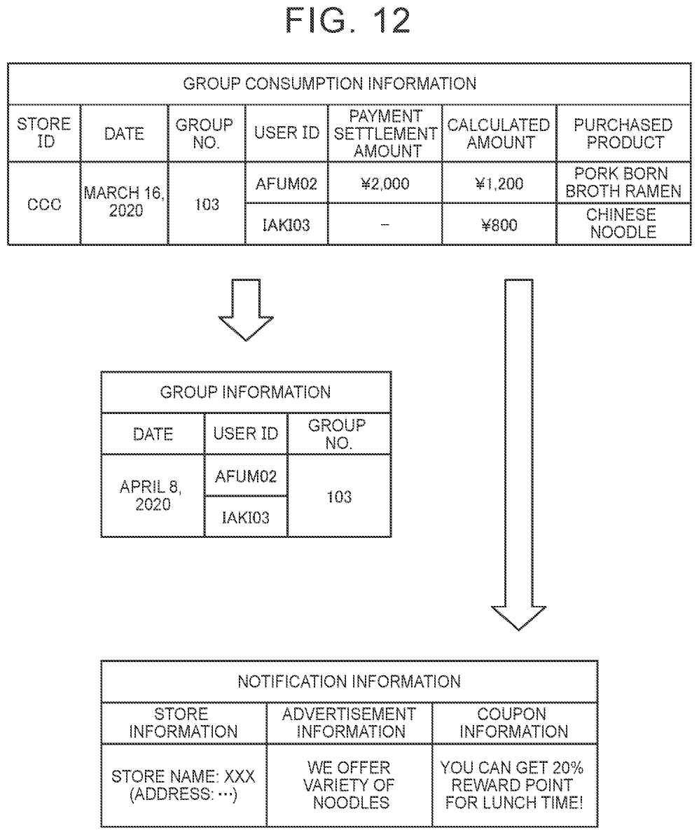

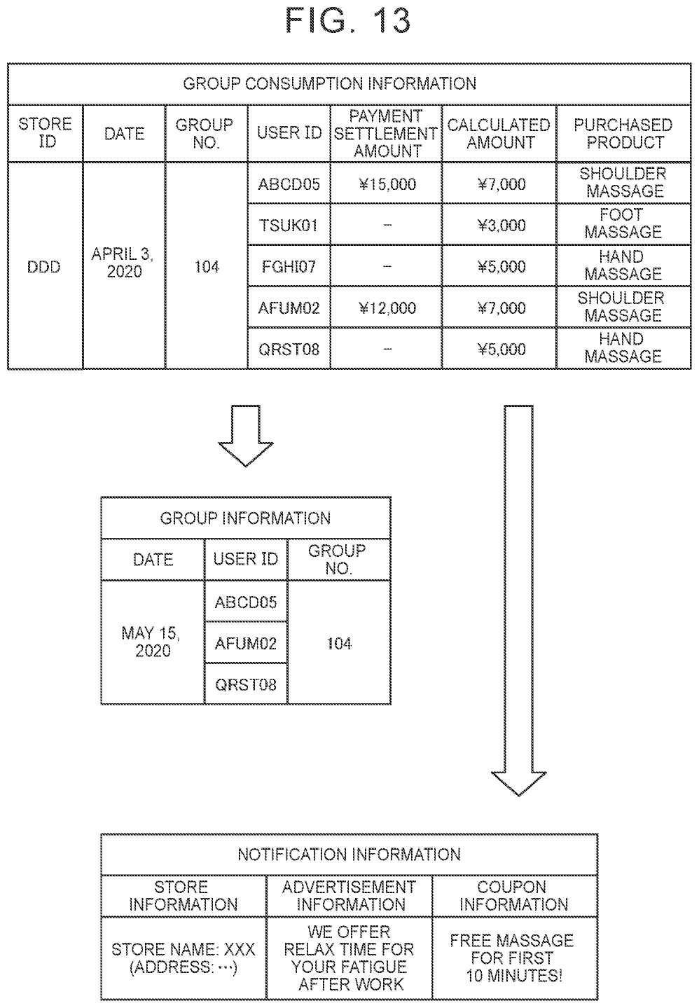

Also in FIGS. 12 and 13, the group information generation unit 112 generates new group information based on the user IDs determined as a group, and the user identification unit 111 can select the notification information 136 based on the generated new group information and the retrieved group consumption information 135.

In a group consisting of a plurality of users, when one of the users pays for the fee of the product or the service provided for the group on behalf of the users in the group, there is a method for estimating the consumption behavior of each of the users and collecting the consumption trend data. However, even when the consumption trend data of each user in the group is accumulated as big data, there is a possibility that usage of the consumption trend data is limited to utilization of the consumption trend data on an individual basis. On the contrary, according to the embodiment of the present disclosure described above, when a plurality of users constitutes a group based on the consumption trend data in the behavior as a group, the information necessary for the group can be retrieved and presented to the users in the group. Therefore, more appropriate information can be presented to the users via the wallet system 1.

Although the embodiment of the present disclosure has been specifically described above, the present disclosure is not limited to the embodiment, and various modifications based on the technical idea of the present disclosure are possible. The present disclosure also includes a configuration in which the components according to the present disclosure are appropriately combined. Further effects and modifications can be easily derived by those skilled in the art. Thus, broader aspects of the present disclosure are not limited to the embodiment, and modifications in various forms can be made. For example, the evaluation screen exemplified in the embodiment is merely an example, and a different evaluation screen may be used as necessary. The present disclosure is not limited by the description and the drawings that constitute a part of the present disclosure according to the present embodiment.

Recoding Media

According to the embodiment, a program capable of executing a processing method by the wallet server 10, the payment service provider server 20, the user terminal 30, and the store terminal 40 can be recorded in a recording medium that is readable by a computer or other machines or devices (hereinafter referred to as the computer). The computer functions as the control units of the wallet server 10 and the user terminal 30 as the computer is caused to read the program stored in the recording medium and execute the program. Here, the recording medium that is readable by the computer means a non-transitory storage medium that accumulates information such as data and programs through an electrical, magnetic, optical, mechanical, or chemical action and from which the computer can read the information. Examples of the recording media removable from the computer among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording media fixed to the computer include a hard disk and a read-only memory (ROM). Further, a solid state drive (SSD) can be used as the recording medium removable from the computer or as the recording medium fixed to the computer.

Information Processing System

As another embodiment, the functions of the user identification unit 111, the group information generation unit 112, and the consumption information generation unit 113 may be divided and executed by a plurality of devices communicable with each other via the network NW.

### Other Embodiments

Further, in the wallet server 10, the payment service provider server 20, the user terminal 30, and the store terminal 40 according to the embodiment, the “unit” can be read as a “circuit”, for example. For example, the communication unit can be read as a communication circuit.

Further, the program to be executed by the wallet server 10, the payment service provider server 20, the user terminal 30, and the store terminal 40 according to the embodiment may be configured to be stored in a computer connected to a network such as the Internet and executed by being downloaded via the network.

In the description of the flowchart in the present specification, the order of the processing between steps is clarified using expressions such as “first”, “after”, and “subsequently”. However, the order of processing required for realizing the embodiment is not always uniquely defined by those representations. That is, the order of processing in the flowchart described in the present specification can be changed within a consistent range.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A wallet server, comprising:
a processor including hardware; and
a memory that stores group consumption information containing group information containing a plurality of pieces of user information of a plurality of user terminals and consumption information associated with the group information, wherein
the processor
acquires notification information to perform notification about a store externally,
retrieves the group consumption information from the memory based on the user information of the user terminals constituting a group,
selects the notification information from the acquired notification information based on the retrieved group consumption information, and
outputs the selected notification information.

2. The wallet server according to claim 1, wherein the processor determines whether the user terminals constitute the group based on location information acquired from the user terminals.

3. The wallet server according to claim 1, wherein the processor determines whether the user terminals constitute the group based on communication between a radio beacon communication unit that is communicable with the user terminals and the user terminals.

4. The wallet server according to claim 1, wherein the processor acquires information on execution of short-range communication mutually between the user terminals, and determines whether the user terminals constitute the group based on whether the short-range communication is executed.

5. The wallet server according to claim 1, wherein the processor selects the notification information to be output based on the consumption information included in the retrieved group consumption information.

6. The wallet server according to claim 1, wherein the processor transmits the selected notification information to at least one of the user terminals that are determined to constitute the group.

7. The wallet server according to claim 1, wherein:
a store terminal provided in the store is configured such that payment settlement processing is executable using the user terminal; and
the processor acquires purchase information containing information on a payment settlement amount in the payment settlement processing and information on a product or a service provided for users who have the user terminals constituting the group, respectively, generates the group consumption information, and accumulates the generated group consumption information in the memory.

8. The wallet server according to claim 1, wherein the group information contains store information related to the store.

9. The wallet server according to claim 1, wherein the notification information contains advertising information and coupon information related to the store.

10. A wallet system, comprising:
a first device that includes a first processor provided with hardware installed in a store and outputting notification information to perform notification about the store externally; and
a second device including a memory that stores group consumption information containing group information containing a plurality of pieces of user information of a plurality of user terminals and consumption information associated with the group information, and a second processor that is provided with hardware, acquires the notification information output from the first device, retrieves the group consumption information from the memory based on the user information of the user terminals constituting a group, selects the notification information from the acquired notification information based on the retrieved group consumption information, and outputs the selected notification information.

11. The wallet system according to claim 10, wherein the second processor determines whether the user terminals constitute the group based on location information acquired from the user terminals.

12. The wallet system according to claim 10, wherein the second processor determines whether the user terminals constitute the group based on communication between a radio beacon communication unit that is communicable with the user terminals and the user terminals.

13. The wallet system according to claim 10, wherein the second processor acquires information on execution of short-range communication mutually between the user terminals, and determines whether the user terminals constitute the group based on whether the short-range communication is executed.

14. The wallet system according to claim 10, wherein the second processor selects the notification information to be output based on the consumption information contained in the retrieved group consumption information.

15. The wallet system according to claim 10, wherein the second processor transmits the selected notification information to at least one of the user terminals that are determined to constitute the group.

16. The wallet system according to claim 10, wherein:
the first device is configured such that payment settlement processing is executable using the user terminal; and
the second processor acquires purchase information containing information on a payment settlement amount in the payment settlement processing and information on a product or a service provided for users who have the user terminals constituting the group, respectively, generates the group consumption information, and accumulates the generated group consumption information in the memory.

17. The wallet system according to claim 10, wherein the group information contains store information related to the store.

18. The wallet system according to claim 10, wherein the notification information contains advertising information and coupon information related to the store.

19. A program that causes a processor provided with hardware to execute:
acquisition of notification information to perform notification about a store externally;
retrieval of group consumption information containing information relating to consumption of a group based on user information of a plurality of user terminals constituting the group from a memory;
selection of the notification information from the acquired notification information based on the retrieved group consumption information; and
output of the selected notification information.

20. The program according to claim 19, wherein the group consumption information contains group information containing a plurality of pieces of the user information of the user terminals, and consumption information associated with the group information.
